(19) United States
(12) Patent Application Publication
(10) Pub. No.: US 2016/0104173 A1
(43) Pub. Date: Apr. 14, 2016

(54) REAL-TIME ECONOMIC INDICATOR

(71) Applicant: Yahoo!, Inc., Sunnyvale, CA (US)

(72) Inventors: Doug Sharp, San Francisco, CA (US); Varun Bhagwan, San Jose, CA (US); Mihajlo Grbovic, Mountain View, CA (US)

(21) Appl. No.: 14/513,935

(22) Filed: Oct. 14, 2014

(51) Int. Cl. G06Q 30/02; H04L 29/06; H04L 12/58

(52) U.S. Cl. CPC G06Q 30/0201; H04L 51/046; H04L 67/42

(57) ABSTRACT

Electronic messages may comprise pieces of economic data, such as an email comprising a first sales receipt and an instant message comprising a second sales receipt. Pieces of economic data may be extracted from electronic messages to obtain a set of extracted economic data. A scale factor may be determined based upon historical economic data (e.g., gross domestic sales data, stock data, etc.). A real-time economic indicator (e.g., a coincident indicator, a leading indicator, etc.) may be determined based upon the set of extracted economic data and the scale factor. The real-time economic indicator may be provided to users, such as through a real-time feedback (e.g., according to a license agreement).

### BACKGROUND

An economic indicator may comprise a statistic used to analyze characteristics of a particular market. Economic indicators may fall into various categories, such as lagging indicators, coincident indicators, and leading indicators. Lagging indicators are economic indicators that react slowly to economic changes, and therefore provide little predictive value. For example, lagging indicators may follow an event (e.g., a war, a financial institution collapse, etc.) because they are historical in nature. Lagging indicators may demonstrate how well a market has performed in the past. This gives economists a chance to review their predictions and make better forecasts (e.g. an unemployment rate is traditionally characterized as a lagging indicator). Profit may be considered a lagging indicator because it reflects historical performance.

Coincident indicators are economic indicators that change at similar times and/or directions as the relevant market (e.g., personal income, gross domestic product (GDP), retail sales, etc.). As such, coincident indicators may generally provide information about the current state of the market. Coincident indicators may be used to identify, after the fact, the dates of peaks and troughs in the economy or sectors of the economy. However, it often takes weeks, months, or even years for relevant economic data to be collected to determine a useful (e.g., accurate) indicator. Leading indicators are economic indicators that predict future changes in the market. A leading indicator can be an indicator that changes before the market changes (e.g., stock prices, which often improve or worsen before a similar change in the market). However, as with coincident indicators, it often takes a considerable period of time to gather and/or report the relevant economic data needed to determine the desired economic indicator.

### SUMMARY

In accordance with the present disclosure, one or more systems and/or methods for predicting a real-time economic indicator are provided. In an example of predicting a real-time economic indicator, a first piece of economic data from a first electronic message and a second piece of economic data from a second electronic message are extracted to obtain a set of extracted economic data. In an example, an electronic message comprises at least one of an email, an instant message, or a social network message. In an example, the first piece of economic data comprises a first sales receipt within a first email, and the second piece of economic data comprises a second sales receipt within a second email. In an example, the set of extracted economic data may be aggregated according to a category. The category may comprise a product, a product class, a seller, a seller class, a purchaser detail, a date/time of sale, a location, etc. A scale factor may be determined based upon historical economic data. In an example, the historical economic data is related to the category. In an example, the historical economic data may comprise stock data, past product sales data, and/or gross domestic sales data. A real-time economic indicator may be determined based upon the set of extracted economic data and/or the scale factor. In an example, the real-time economic indicator comprises at least one of a leading indicator or a coincident indicator. In an example, a real-time feed of the real-time economic indicator is provided to a client according to a license agreement.

In an example, the real-time economic indicator may be updated in real-time based upon a third piece of economic data extracted from a third electronic message. In an example, economic user feedback may be received for the real-time economic indicator. The real-time economic indicator may be adjusted based upon the economic user feedback to obtain an adjusted real-time economic indicator. The economic user feedback may comprise at least one of a suggested economic data source, a suggested weighting factor for the suggested economic data source, or a physical sales receipt.

### DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1 is an illustration of a scenario involving various examples of networks that may connect servers and clients.

FIG. 2 is an illustration of a scenario involving an exemplary configuration of a server that may utilize and/or implement at least a portion of the techniques presented herein.

FIG. 3 is an illustration of a scenario involving an exemplary configuration of a client that may utilize and/or implement at least a portion of the techniques presented herein.

FIG. 4A is a component block diagram illustrating an exemplary system for predicting a real time economic indicator.

FIG. 4B is a component block diagram illustrating an exemplary system for predicting a real time economic indicator, where the real-time economic indicator is provided.

FIG. 4C is a component block diagram illustrating an exemplary system for predicting a real time economic indicator, where the real-time economic indicator is provided as a real-time feed according to a license agreement.

FIG. 4D is a component block diagram illustrating an exemplary system for predicting a real time economic indicator, where the real-time economic indicator is adjusted based upon economic user feedback.

FIG. 5 is a flow chart illustrating an exemplary method of predicting a real-time economic indicator, where economic data is extracted from an electronic communication.

FIG. 6 is an illustration of a scenario featuring an exemplary nontransitory memory device in accordance with one or more of the provisions set forth herein.

FIG. 7 is a diagram of a scenario of a search engine/service that provides search results in response to a search query in accordance with one or more of the provision set forth herein.

### DETAILED DESCRIPTION

Subject matter will now be described more fully hereinafter with reference to the accompanying drawings, which form a part hereof, and which show, by way of illustration, specific example embodiments. This description is not intended as an extensive or detailed discussion of known concepts. Details that are known generally to those of ordinary skill in the relevant art may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof.

1. Computing Scenario

The following provides a discussion of some types of computing scenarios in which the disclosed subject matter may be utilized and/or implemented.

1.1. Networking

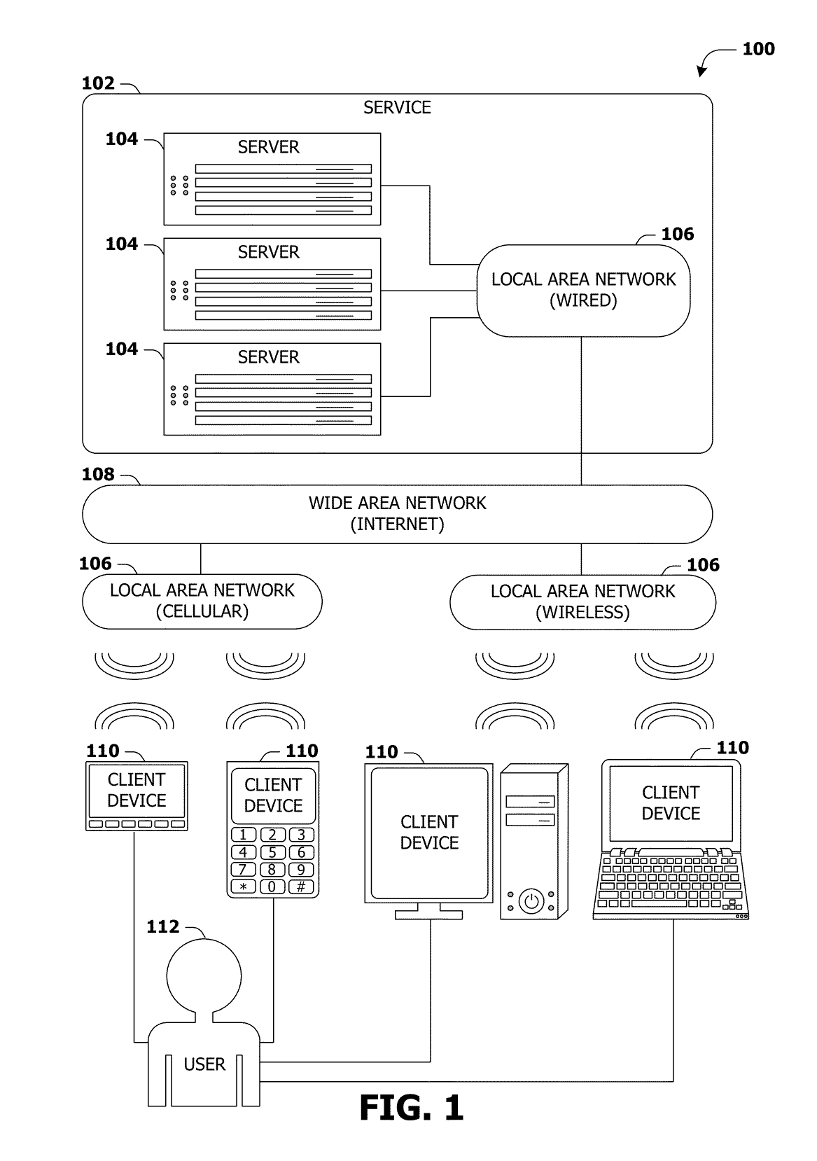

FIG. 1 is an interaction diagram of a scenario 100 illustrating a service 102 provided by a set of servers 104 to a set of client devices 110 via various types of networks. The servers 104 and/or client devices 110 may be capable of transmitting, receiving, processing, and/or storing many types of signals, such as in memory as physical memory states.

The servers 104 of the service 102 may be internally connected via a local area network 106 (LAN), such as a wired network where network adapters on the respective servers 104 are interconnected via cables (e.g., coaxial and/or fiber optic cabling), and may be connected in various topologies (e.g., buses, token rings, meshes, and/or trees). The servers 104 may be interconnected directly, or through one or more other networking devices, such as routers, switches, and/or repeaters. The servers 104 may utilize a variety of physical networking protocols (e.g., Ethernet and/or Fibre Channel) and/or logical networking protocols (e.g., variants of an Internet Protocol (IP), a Transmission Control Protocol (TCP), and/or a User Datagram Protocol (UDP). The local area network 106 may include, e.g., analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. The local area network 106 may be organized according to one or more network architectures, such as server/client, peer-to-peer, and/or mesh architectures, and/or a variety of roles, such as administrative servers, authentication servers, security monitor servers, data stores for objects such as files and databases, business logic servers, time synchronization servers, and/or front-end servers providing a user-facing interface for the service 102.

Likewise, the local area network 106 may comprise one or more sub-networks, such as may employ differing architectures, may be compliant or compatible with differing protocols and/or may interoperate within the local area network 106. Additionally, a variety of local area networks 106 may be interconnected; e.g., a router may provide a link between otherwise separate and independent local area networks 106.

In the scenario 100 of FIG. 1, the local area network 106 of the service 102 is connected to a wide area network 108 (WAN) that allows the service 102 to exchange data with other services 102 and/or client devices 110. The wide area network 108 may encompass various combinations of devices with varying levels of distribution and exposure, such as a public wide-area network (e.g., the Internet) and/or a private network (e.g., a virtual private network (VPN) of a distributed enterprise).

In the scenario 100 of FIG. 1, the service 102 may be accessed via the wide area network 108 by a user 112 of one or more client devices 110, such as a portable media player (e.g., an electronic text reader, an audio device, or a portable gaming, exercise, or navigation device); a portable communication device (e.g., a camera, a phone, a wearable or a text chatting device); a workstation; and/or a laptop form factor computer. The respective client devices 110 may communicate with the service 102 via various connections to the wide area network 108. As a first such example, one or more client devices 110 may comprise a cellular communicator and may communicate with the service 102 by connecting to the wide area network 108 via a wireless local area network 106 provided by a cellular provider. As a second such example, one or more client devices 110 may communicate with the service 102 by connecting to the wide area network 108 via a wireless local area network 106 provided by a location such as the user's home or workplace (e.g., a WiFi network or a Bluetooth personal area network). In this manner, the servers 104 and the client devices 110 may communicate over various types of networks. Other types of networks that may be accessed by the servers 104 and/or client devices 110 include mass storage, such as network attached storage (NAS), a storage area network (SAN), or other forms of computer or machine readable media.

1.2. Server Configuration

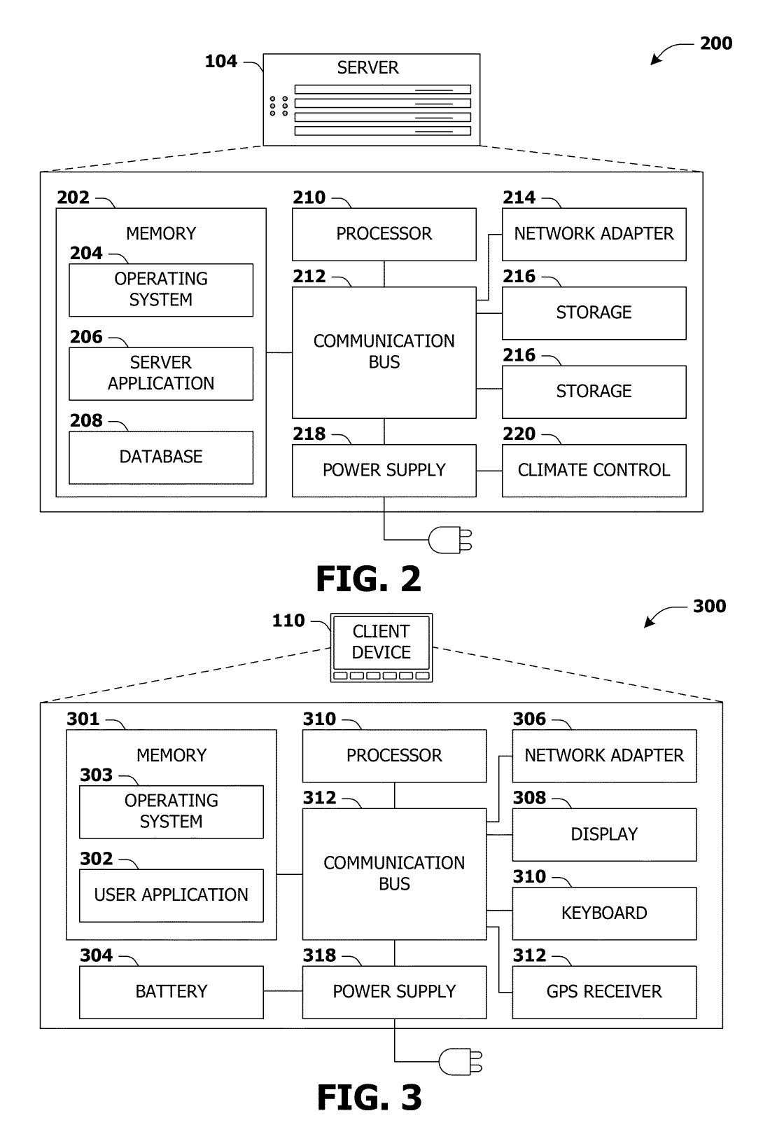

FIG. 2 presents a schematic architecture diagram 200 of a server 104 that may utilize at least a portion of the techniques provided herein. Such a server 104 may vary widely in configuration or capabilities, alone or in conjunction with other servers, in order to provide a service such as the service 102.

The server 104 may comprise one or more processors 210 that process instructions. The one or more processors 210 may optionally include a plurality of cores; one or more coprocessors, such as a mathematics coprocessor or an integrated graphical processing unit (GPU); and/or one or more layers of local cache memory. The server 104 may comprise memory 202 storing various forms of applications, such as an operating system 204; one or more server applications 206, such as a hypertext transport protocol (HTTP) server, a file transfer protocol (FTP) server, or a simple mail transport protocol (SMTP) server; and/or various forms of data, such as a database 208 or a file system. The server 104 may comprise a variety of peripheral components, such as a wired and/or wireless network adapter 214 connectible to a local area network and/or wide area network; one or more storage components 216, such as a hard disk drive, a solid-state storage device (SSD), a flash memory device, and/or a magnetic and/or optical disk reader.

The server 104 may comprise a mainboard featuring one or more communication buses 212 that interconnect the processor 210, the memory 202, and various peripherals, using a variety of bus technologies, such as a variant of a serial or parallel AT Attachment (ATA) bus protocol; a Uniform Serial Bus (USB) protocol; and/or Small Computer System Interface (SCI) bus protocol. In a multibus scenario, a communication bus 212 may interconnect the server 104 with at least one other server. Other components that may optionally be included with the server 104 (though not shown in the schematic diagram 200 of FIG. 2) include a display; a display adapter, such as a graphical processing unit (GPU); input peripherals, such as a keyboard and/or mouse; and a flash memory device that may store a basic input/output system (BIOS) routine that facilitates booting the server 104 to a state of readiness.

The server 104 may operate in various physical enclosures, such as a desktop or tower, and/or may be integrated with a display as an “all-in-one” device. The server 104 may be mounted horizontally and/or in a cabinet or rack, and/or may simply comprise an interconnected set of components. The server 104 may comprise a dedicated and/or shared power supply 218 that supplies and/or regulates power for the other components. The server 104 may provide power to and/or receive power from another server and/or other devices. The server 104 may comprise a shared and/or dedicated climate control unit 220 that regulates climate properties, such as temperature, humidity, and/or airflow. Many such servers 104 may be configured and/or adapted to utilize at least a portion of the techniques presented herein.

1.3. Client Device Configuration

FIG. 3 presents a schematic architecture diagram 300 of a client device 110 whereupon at least a portion of the techniques presented herein may be implemented. Such a client device 110 may vary widely in configuration or capabilities, in order to provide a variety of functionality to a user such as the user 112. The client device 110 may be provided in a variety of form factors, such as a desktop or tower workstation; an “all-in-one” device integrated with a display 308; a laptop, tablet, convertible tablet, or palmtop device; a wearable device mountable in a headset, eyeglass, earpiece, and/or wristwatch, and/or integrated with an article of clothing; and/or a component of a piece of furniture, such as a tabletop, and/or of another device, such as a vehicle or residence. The client device 110 may serve the user in a variety of roles, such as a workstation, kiosk, media player, gaming device, and/or appliance.

The client device 110 may comprise one or more processors 310 that process instructions. The one or more processors 210 may optionally include a plurality of cores; one or more coprocessors, such as a mathematics coprocessor or an integrated graphical processing unit (GPU); and/or one or more layers of local cache memory. The client device 110 may comprise memory 301 storing various forms of applications, such as an operating system 303; one or more user applications 302, such as document applications, media applications, file and/or data access applications, communication applications such as web browsers and/or email clients, utilities, and/or games; and/or drivers for various peripherals. The client device 110 may comprise a variety of peripheral components, such as a wired and/or wireless network adapter 306 connectible to a local area network and/or wide area network; one or more output components, such as a display 308 coupled with a display adapter (optionally including a graphical processing unit (GPU)), a sound adapter coupled with a speaker, and/or a printer; input devices for receiving input from the user, such as a keyboard 310, a mouse, a microphone, a camera, and/or a touch-sensitive component of the display 308; and/or environmental sensors, such as a global positioning system (GPS) receiver 312 that detects the location, velocity, and/or acceleration of the client device 110, a compass, accelerometer, and/or gyroscope that detects a physical orientation of the client device 110. Other components that may optionally be included with the client device 110 (though not shown in the schematic diagram 300 of FIG. 3) include one or more storage components, such as a hard disk drive, a solid-state storage device (SSD), a flash memory device, and/or a magnetic and/or optical disk reader; and/or a flash memory device that may store a basic input/output system (BIOS) routine that facilitates booting the client device 110 to a state of readiness; and a climate control unit that regulates climate properties, such as temperature, humidity, and airflow.

The client device 110 may comprise a mainboard featuring one or more communication buses 312 that interconnect the processor 310, the memory 301, and various peripherals, using a variety of bus technologies, such as a variant of a serial or parallel AT Attachment (ATA) bus protocol; the Uniform Serial Bus (USB) protocol; and/or the Small Computer System Interface (SCI) bus protocol. The client device 110 may comprise a dedicated and/or shared power supply 318 that supplies and/or regulates power for other components, and/or a battery 304 that stores power for use while the client device 110 is not connected to a power source via the power supply 318. The client device 110 may provide power to and/or receive power from other client devices.

In some scenarios, as a user 112 interacts with a software application on a client device 110 (e.g., an instant messenger and/or electronic mail application), descriptive content in the form of signals or stored physical states within memory (e.g., an email address, instant messenger identifier, phone number, postal address, message content, date, and/or time) may be identified. Descriptive content may be stored, typically along with contextual content. For example, the source of a phone number (e.g., a communication received from another user via an instant messenger application) may be stored as contextual content associated with the phone number. Contextual content, therefore, may identify circumstances surrounding receipt of a phone number (e.g., the date or time that the phone number was received), and may be associated with descriptive content. Contextual content, may, for example, be used to subsequently search for associated descriptive content. For example, a search for phone numbers received from specific individuals, received via an instant messenger application or at a given date or time, may be initiated. The client device 110 may include one or more servers that may locally serve the client device 110 and/or other client devices of the user 112 and/or other individuals. For example, a locally installed webserver may provide web content in response to locally submitted web requests. Many such client devices 110 may be configured and/or adapted to utilize at least a portion of the techniques presented herein.

2. Presented Techniques

One or more techniques and/or systems for predicting a real-time economic indicator are provided herein. Often, when a user purchases a product or service from an online retailer, the retailer sends an electronic message (e.g., email) containing economic data (e.g. a sales receipt) regarding the user's purchase. Moreover, physical stores (e.g., brick-and-mortar stores) may give users the option to have receipts sent as electronic messages when a user purchases a product or service. As provided herein, the economic data may be extracted from the electronic message to obtain extracted economic data (e.g., information about the item that the user purchased, a purchase price, a seller of the item, and/or other information extracted from the sales receipt of the email). The extracted economic data may be aggregated into a category based upon the extracted economic data matching the category. The category may comprise a product (e.g., a car manufacturer, a cellphone model, a television model, etc.), a product class (e.g., American made cars, smartphones, televisions, etc.), a seller (e.g., an internet retailer, a company with a retail store from and an online shopping website, etc.), a location (e.g., location of the purchaser, a location of the purchase, a location of the seller, etc.), or combinations thereof. A scale factor for the category may be determined based upon the historical economic data for the category (e.g., past sales of American made cars in Jan.). In an example, a scale factor may be determined by comparing the extracted economic data to a prior profit report related to the category. The extracted economic data and the scale factor may be used to determine a real-time economic indicator. It may be appreciated that in one example real-time may correspond to varying degrees of temporal relatedness, such as contemporaneously, near real-time, relatively real-time, etc. (e.g., a 1 month delay, a 1 week delay, a 1 day delay, a 5 minute delay, a 1 minute delay, a 20 second delay, or any other threshold temporal relatedness that may be relevant). The real-time economic indicator may be provided as a real-time feed that is updated in real-time when additional electronic communications (e.g. emails) containing economic data become available. Accordingly, the real-time economic indicator may be able to effectively and efficiently predict economic trends by providing real-time purchasing information to various users (e.g., a financial website, an investment group, etc.).

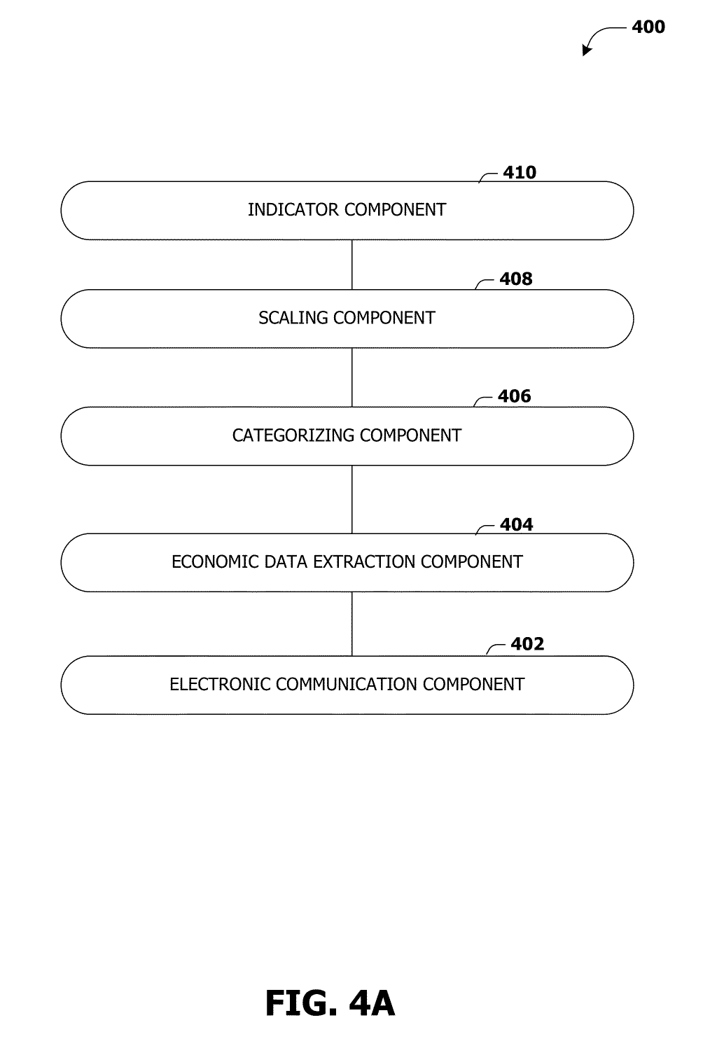

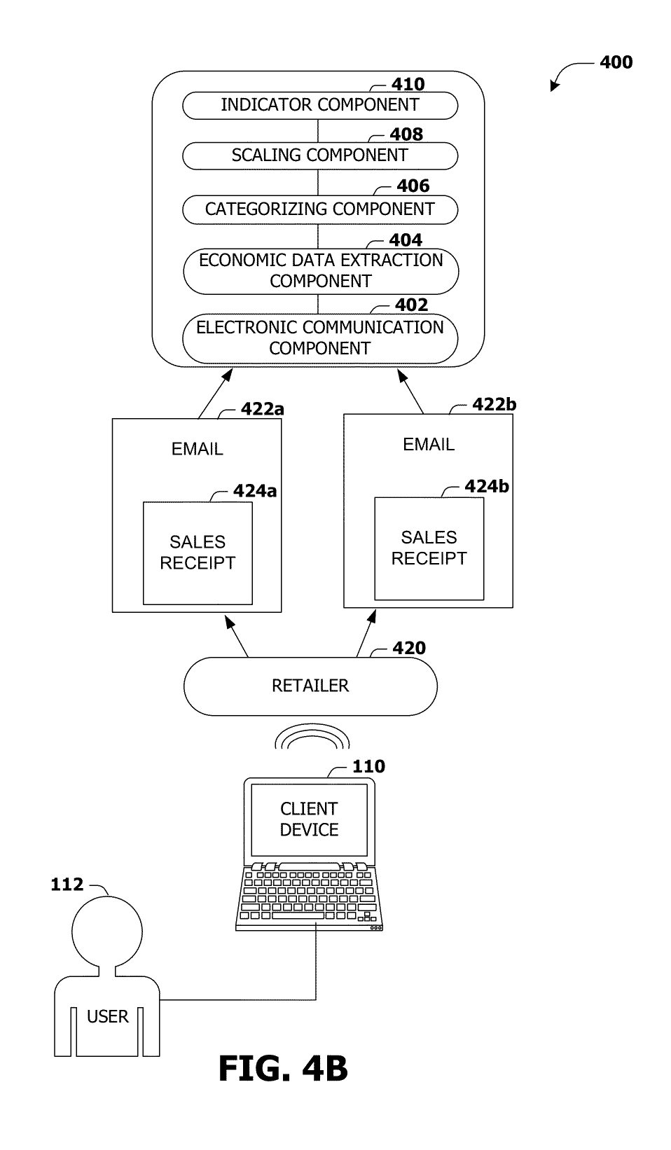

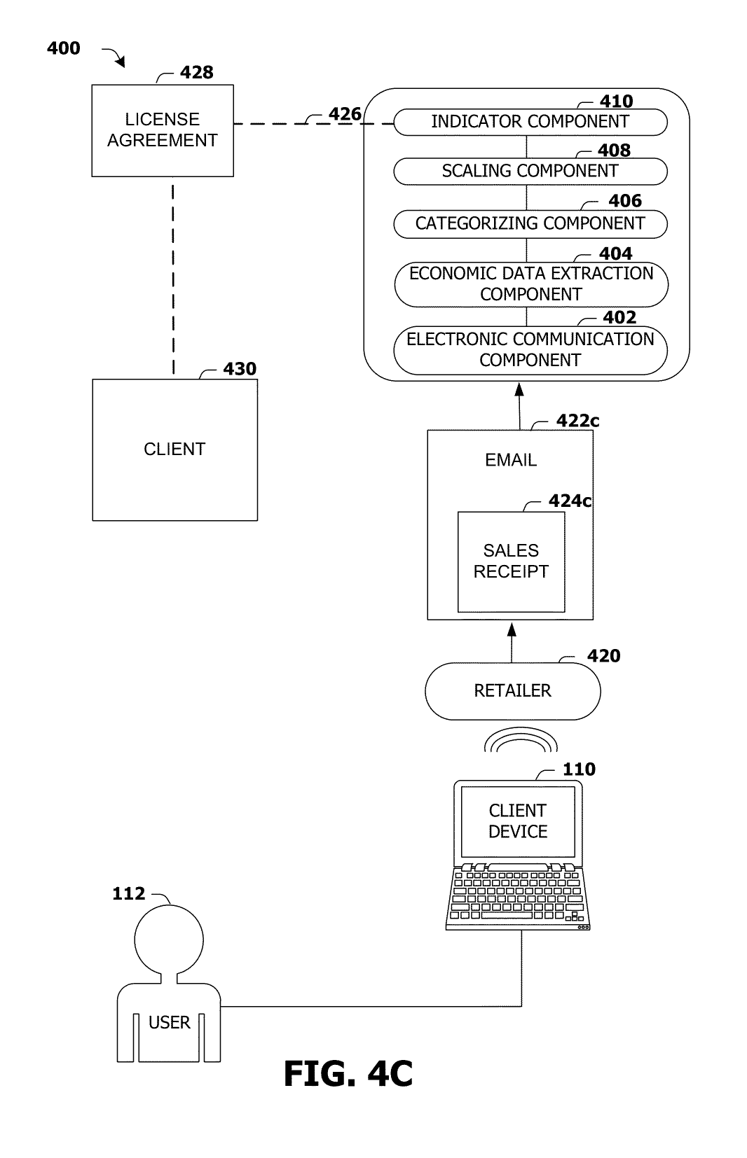

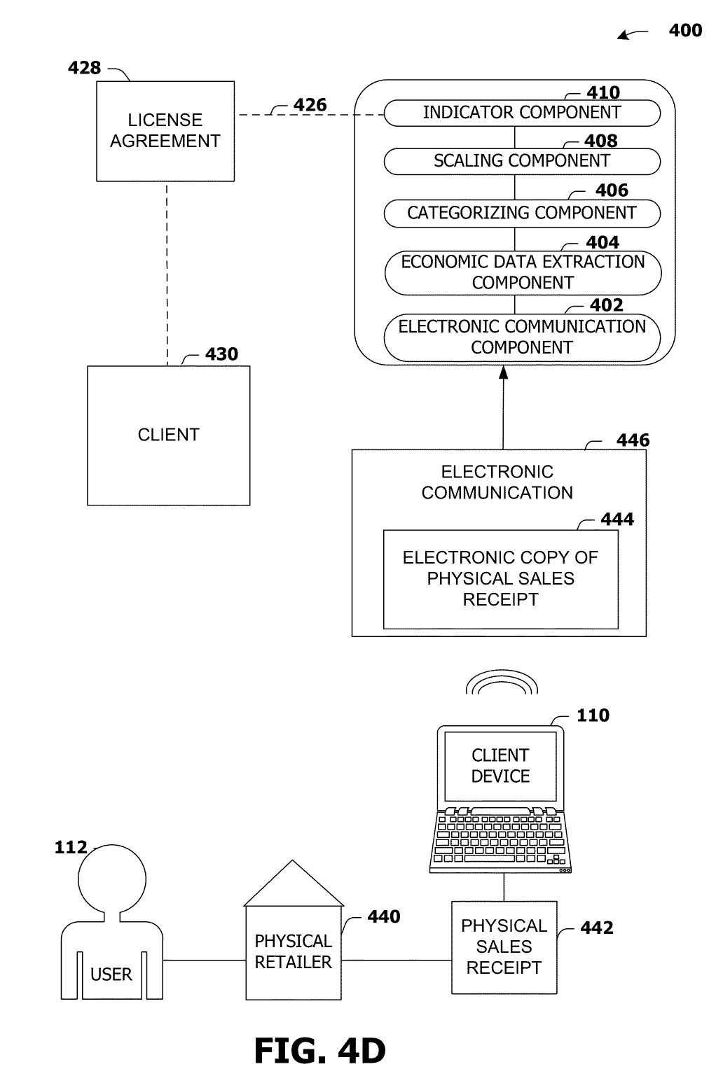

FIG. 4A-4D illustrate examples of a system 400 for predicting a real-time economic indicator. The system 400 may comprise an electronic communication component 402, an economic data extraction component 404, a categorizing component 406, a scaling component 408, and/or an indicator component 410, as illustrated in FIG. 4A. The electronic communication component 402 (e.g., an email network/server, an instant message network/server, etc.) may be configured to facilitate communication of electronic messages, such as a first electronic message, a second electronic message, and/or other electronic messages. The first electronic message may comprise a first piece of economic data. The second electronic message may comprise a second piece of economic data. An electronic message may comprise an email, an instant message, a social network message, or other type of message. In an example, the first piece of economic data may comprise a first sales receipt 424a within a first email 422a, and the second piece of economic data may comprise a second sales receipt 424b within a second email 422b, as illustrated in FIG. 4B. The first sales receipt 424a and/or the second sales receipt 424b may be provided by a retailer 420, such as an online retailer or a retail storefront that provides sales receipts via electronic communication. In an example, the first sales receipt 424a and/or the second sales receipt 424b may be provided in response to a user 112 placing orders for items though a client device 110 (e.g. a computer, a smart phone, a tablet, etc.). The first sales receipt 424a and/or the second sales receipt 424b may comprises a date/time of a purchase, an item purchased (e.g., cellphone, eggs, toothbrush, etc.), a service purchased (e.g., online tax service, printing service, etc.), a purchase price, a discount applied to the purchase, the tax paid for the purchase, a sellers name, a location of the seller, a web address of the seller, the method of payment (e.g., credit card, cash on delivery, etc.), a shipping address, a shipping method, a billing address, and/or an optical representation of data (e.g., a barcode, quick response code, etc.).

The economic data extraction component 404 may be configured to extract one or more pieces of economic data from one or more electronic messages (e.g., a single piece of economic data from a single electronic message; multiple pieces of economic data from a single electronic message; multiple pieces of economic data from various electronic messages; etc.). For example, the first piece of economic data from the first electronic message (e.g., information within the sales receipt 424a) may be extracted to obtain a first piece of extracted economic data. In an example, the economic data extraction component 404 may be configured to extract a second piece of economic data from a second message (e.g., information within the sales receipt 424b) to obtain a second piece of extracted economic data. In this way, a set of extracted economic data may be obtained. The set of extracted economic data may comprise between about 0.1% to about 5% or any other percentage of the gross domestic sales for an economy as a whole and/or for a product category (e.g., electronic sales, e-book sales, cellphone sales, etc.).

The economic data extraction component 404 may comprise an automatic identification and data capture (AIDC) component. The AIDC component may process the first electronic message and/or the second electronic message. The AIDC component may automatically identify objects (e.g., text, images, etc.), collect data about the objects (e.g. identify the text as belonging to a sales receipt, etc.), and enter the data into a data processing component (e.g. a computer system, etc.) for additional processing. In an example, the AIDC may comprise an optical character recognition (OCR) program, an optical barcode recognition (OBR) program, a document layer recognition (DLR) program, or an intelligent character recognition (ICR) program. The economic data extraction component 404 may be configured to recognize and process economic data from a structured document (e.g., tax return, insurance forms, etc.), a semi-structured document (e.g., invoices, purchase orders, sales receipts, waybills, etc.), and/or an unstructured document (e.g., contracts, letters, etc.).

The categorizing component 406 may be configured to aggregate the first piece of extracted economic data, the second piece of economic data, and/or other pieces of economic data into a first category. The first category may comprise a product (e.g., a cellphone model, a car model, etc.), a product class (e.g., cell phones, electronics, American manufactured cars, food, online dating sites, etc.), a seller (a retailer, a website, an individual, etc.), a seller class (e.g., cellphone retailers, home improvement retailers, an online auction seller, etc.), a purchaser detail (e.g., gender, age, income bracket, etc. of a purchaser), a date/time of sale (e.g., sales at 4 pm on a Tuesday, sales on March 3^{rd}, sales in April, etc.), and/or a location (e.g., country, state, city, zip code, etc.).

In an example, the categorizing component 406 may aggregate a first sales receipt for a first product into a first category (e.g., a first sales receipt for a cellphone sold in Ohio can be aggregated into an Ohio sales category), and may aggregate a second sales receipt for a second product into a second category (e.g., a second sales receipt for a second cellphone sold in New York can be placed into a New York sales category).

In another example, the extracted economic data may be aggregated into a first category based upon an identifier in an electronic message, such as a retailer's email address (e.g., orders@bigonlineretailer.com), an internet protocol address, etc.

In an example, the categorizing component 406 may be configured to aggregate the extracted economic data in the first category into a first subcategory (e.g., a first sales receipt for a cellphone sold in Cleveland may be aggregated into a cellphone category and then aggregated into a 44101 zip code subcategory). The subcategory may comprise a product, a product class, a seller, a seller class, a purchaser detail, a date/time of sale, or a location (e.g., location of the purchaser). In this way, extracted economic data may be aggregated into categories and/or subcategories.

The scaling component 408 may be configured to determine a scale factor. The scale factor may be determined based on historical economic data (e.g., if the extracted economic data for a first cellphone showed 10 million cellphones sold in 2013 and the annual sales for the first cellphone in 2013 was 100 million cellphones, then the scale factor would be 10%) . The historical economic data may comprise stock data, past product sales data, and/or gross domestic sales data. In an example, the scale factor may be based on historical economic data for the first category (e.g., gross domestic sales data for cellphones in 2013, total sales for eggs in Ohio during 2013, etc.). The scale factor may comprise a multiplier (e.g., a percentage) used to associate the set of extracted economic data to a market as a whole for a time period (e.g., a multiplier may be used to determine 100.0% of cellphone sales in Ohio on March 3^{rd} based upon a set of extracted economic data equating to about 1.0% of cellphone sales).

The indicator component 410 may be configured to determine a real-time economic indicator for the first category. The real-time economic indicator may comprise at least one of a leading indicator, a coincident indicator, or any other indictor type. The indicator component 410 may determine the real-time economic indicator based on the scale factor and/or the set of extracted economic data, such as the first piece of extracted economic data and/or the second piece of extracted economic data. The real-time economic indicator may provide a real-time economic predication for a first category. For example, if a set of extracted economic data (e.g., sales receipts in emails received by an email network) comprises about 1.0% of the total sales for products in a first category (e.g., electronic sales) for a time period (e.g., previous 10 weeks, previous 24 hours, etc.), a scale factor may be used to determine 100.0% of the total sales for the first category. Thus, the current economic state of the first category may be predicted based upon the real-time economic indicator for the first category (e.g., the real-time economic indicator can be used to predict an increase or decrease in a product sales, a rise or fall in a stock price, an increase or decrease in a price of a product, etc.). Accordingly, the real-time economic indicator may be useful for predicting economic trends based upon real-time purchasing information and/or the current economic state of a category.

The indicator component 410 may be configured to update the real-time economic indicator in real-time based upon a third piece of economic data being extracted from a third electronic message, as illustrated in FIG. 4C. For example, the user 112 may purchase an item from the retailer 420 through the client device 110. The online retailer 420 may transmit a third email 422c comprise a third sales receipt 424c to the electronic communication component 402. The third sales receipt 424c may be extracted by the economic data extraction component 404 to obtain an extracted third piece of economic data. The extracted third piece of economic data can be categorized by the categorizing component 406. The indicator component 410 can update a real-time economic indicator based upon the extracted third piece of economic data extracted from the third sales receipt 424c to obtain an updated real-time economic indicator. The updated real-time economic indicator may then be transmitted by a real-time feed 426 to a client 430. In an example, the real-time feed 426 may comprise a raw feed (e.g., unfiltered feed containing economic data from many categories) or a filtered feed. The filtered feed may comprise a real-time economic indicator for one or more specific categories. The real-time feed 426 may be provided to the client 430 according to a license agreement 428. The license agreement 428 may indicate the terms of access to the real-time feed 426 (e.g., cost of access, categories of access, time of access, etc.).

The real-time economic indicator may be adjusted based upon economic user feedback to obtain an adjusted real-time economic indicator, as illustrated in FIG. 4D. The economic user feedback may comprise at least one of a suggested economic data source (e.g., sales data for eggs sales from a local farmers market), a suggested weighting factor for the suggested economic data source (e.g., a weighting factor that suggest that the egg sales at the local farmers market accounts for 1.0% of the egg sales in Ohio, and that the egg sales are at a typical price for Ohio) , or a physical sales receipt (e.g. a paper sales receipt from a brick and mortar retail store).The real-time economic indicator may be adjusted to account for sales in physical stores (e.g., a brick and mortar home improvement store that does not supply electronic sales receipts). In an example, the user 112 may purchase an item (e.g. a blender) from a physical retailer 440 (e.g., a brick and mortar store that does not provide electronic sales receipts). The physical retailer 440 may provide the user 112 with a physical sales receipt 442 (e.g., a hand written sales receipt, a printed sales receipt, etc.) for the purchase of the item (e.g., the blender). The user 112 may process (e.g., scan the physical sales receipt 442; manually input the economic data from the physical sales receipt 442; etc.) the physical sales receipt 442 to obtain an electronic copy of the physical sales receipt 444. The user 112 may transmit the electronic copy of the physical sales receipt 444 from the client device 110 to the electronic communication component 402 in an electronic communication 446 (e.g., an email, an instant message, etc.). The electronic copy of the physical sales receipt 444 may be extracted by the economic data extraction component 404 to obtain an extracted piece of economic data. The extracted piece of economic data can be categorized by the categorizing component 406. The indicator component 410 can adjust the real-time economic indicator based upon the economic user feedback (e.g., based upon the extracted piece of economic data from the physical sales receipt 442) to obtain an adjusted real-time economic indicator. The adjusted real-time economic indicator may be transmitted by the real-time feed 426 to the client 430 according to the license agreement 428. In an example, the user 112 may provide the economic user feedback through a completion interface (e.g., application, website, etc.). The completion interface may be configured to assign points to the user 112 based upon the relevancy and/or accuracy of the economic user feedback. If the user 112 accumulates a predetermined number of points, the user 112 may win a prize (e.g., money, a license agreement to access a real-time indicator feed, etc.). The economic user feedback may improve the accuracy of the real-time economic indicator by accounting for sales of retailers that may not transmit sales receipts by electronic communications (e.g., emails, social networking messages, etc.).

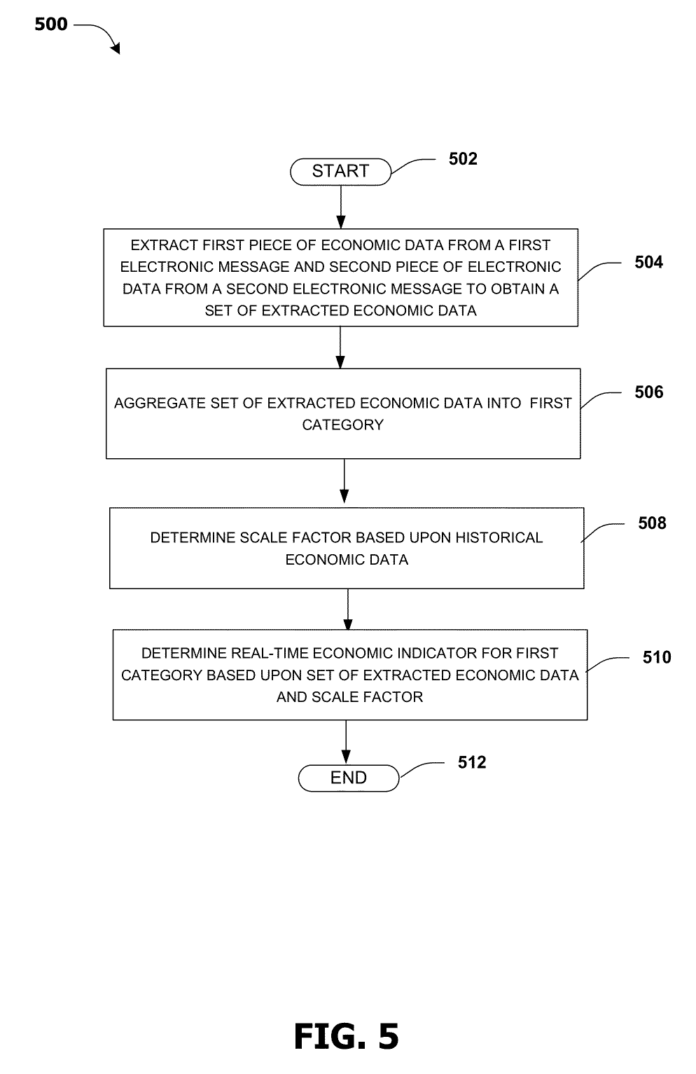

An embodiment for predicting a real-time economic indicator is illustrated by an exemplary method 500 of FIG. 5. At 502, the method starts. At 504, a first piece of economic data from a first electronic message and/or a second piece of economic data from a second electronic message are extracted to obtain a set of extracted economic data. In an example, the first electronic message and/or the second electronic message may comprise an email, an instant message, and/or a social network message. In an example, the first piece of economic data may comprise a first sales receipt within a first email, and the second piece of economic data may comprising a second sales receipt within a second email. The sales receipts may be provided by an online retail store and/or a physical retail store that provides electronic sales receipts (e.g., a physical retail store that emails customers sales receipts). The sales receipts may comprises a date/time of a purchase, an item purchased, a service purchased, a purchase price, a discount applied to the purchase, a tax paid for the purchase, a location of the store or store website address where the purchase was made, a method of payment, a shipping address, a shipping method, a billing address, and/or an optical representation of data (e.g., a barcode, quick response code, etc.). In an example, the first electronic message and/or the second electronic message may be processed by an automatic identification and data capture (AIDC) component.

At 506, the set of extracted economic data may be aggregated into a first category. The first category may comprise a product (e.g., a cellphone model, a car model, etc.), a product class (e.g., cell phones, electronics, American manufactured cars, food, online dating sites, etc.), a seller (a retailer, a website, an individual, etc.), a seller class (e.g., cellphone retailers, home improvement retailers, etc.), a purchaser detail (e.g., gender, age, income bracket, etc. of a purchaser), a date/time of sale (e.g., sales at 4 pm on a Tuesday, sales on March 3^{rd}, sales in April, etc.), and/or a location (e.g., country, state, city, zip code, etc.). In an example, a first sales receipt for a first product can be aggregated into the first category and/or a first subcategory (e.g., a videogame category and a racing videogame subcategory). In an example, a second sales receipt for a second product can be aggregated into a second category and/or a second subcategory. A subcategory may comprise a product, a product class, a seller, a seller class, a purchaser detail, a date/time of sale, or a location.

At 506, a scale factor is determined. In an example, the scale factor is based upon historical economic data (e.g., prior sales for a product, a region, a timeframe, etc.). The scale factor may be based on historical economic data for the first category (e.g., total sales for videogames in the United States during March of 2014, total sales for videogame consoles in Ohio during 2013, etc.). The scale factor may comprise a multiplier used to associate the set of extracted economic data to a market as a whole for a time period (e.g., a multiplier may be used to determine 100.0% of videogame sales in Ohio on March 3^{rd} based upon a set of extracted economic data equating to 1.0% of cellphone sales in Ohio on March 3^{rd}).

At 508, a real-time economic indicator is determined. The real-time economic indicator may comprise a leading indicator, a coincident indicator, or any other indicator type. The real time economic indicator may be determined based upon the set of extracted economic data and the scale factor. In an example, the real-time economic indicator is determined for the first category. The real-time economic indicator may provide a real-time economic prediction for the first category.

The real-time economic indicator may be updated in real-time based upon a third piece of economic data being extracted from a third electronic message to obtain an updated real-time economic indicator. The updated real-time economic indicator may be configured as a real-time feed. The updated real-time economic indicator may be transmitted by the real-time feed to a client. In an example, the real-time feed may comprise a raw feed (e.g., unfiltered feed containing economic data from many categories) or a filtered feed. The real-time feed may be provided to a client according to a license agreement. The license agreement may indicate the terms of access to the real-time feed (e.g., cost of access, categories of access, time of access, etc.).

The real-time economic indicator may be adjusted based upon economic user feedback to obtain an adjusted real-time economic indicator. The economic user feedback may comprise at least one of a suggested economic data source (e.g., sales data for videogame sales from a local videogame retailer), a suggested weighting factor for the suggested economic data source (e.g., a weighting factor that indicates prices at the local videogame retailer are 10% higher than at online videogame retailers), or a physical sales receipt (e.g. paper sales receipt from a brick and mortar retail store). The real-time economic indicator may be adjusted to account for sales in physical stores (e.g., a brick and mortar local videogame retailer may not supply electronic sales receipts). The adjusted real-time economic indicator may be transmitted by a real-time feed to a client according to a license agreement. In an example, a user may provide the economic user feedback through a completion interface (e.g., application, website, etc.). The completion interface may be configured to assign points to the user based upon the relevancy and/or accuracy of the economic user feedback. The economic user feedback may improve the accuracy of the real-time economic indicator by accounting for sales of retailers that may not transmit sales receipts by electronic communications (e.g., emails, social networking messages, etc.). At 512, the method ends.

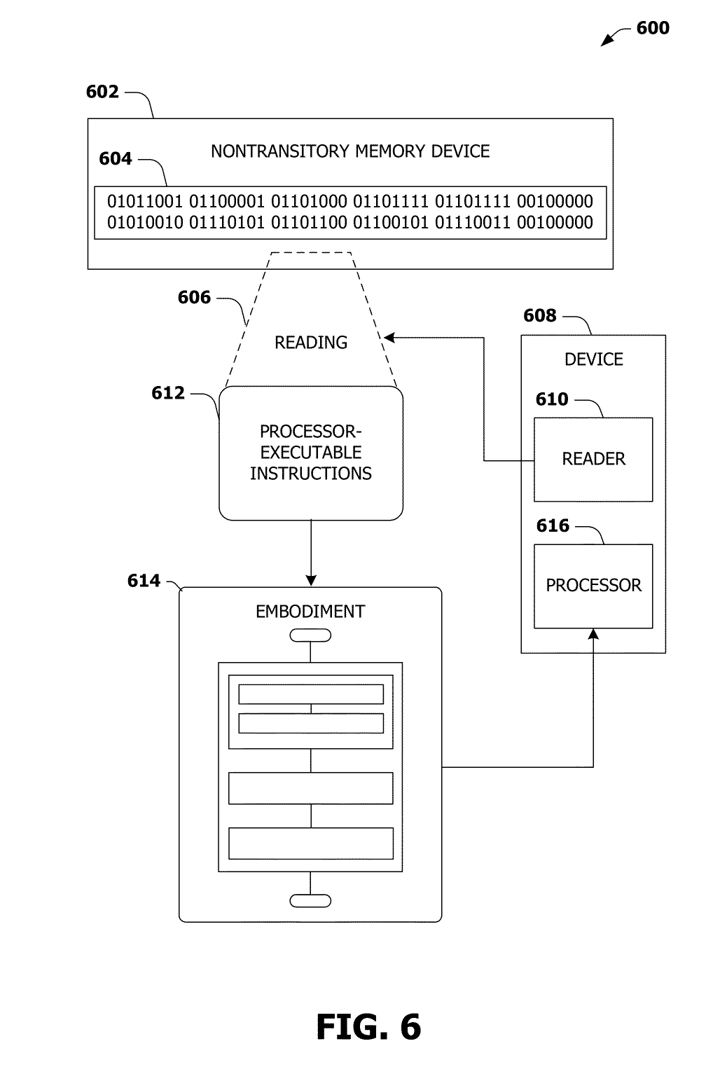

FIG. 6 is an illustration of a scenario 600 involving an exemplary nontransitory memory device 602. The nontransitory memory device 602 may comprise instructions that when executed perform at least some of the provisions herein. The nontransitory memory device may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a CD, DVD, or floppy disk). The exemplary nontransitory memory device 602 stores computer-readable data 604 that, when subjected to reading 606 by a reader 610 of a device 608 (e.g., a read head of a hard disk drive, or a read operation invoked on a solid-state storage device), express processor-executable instructions 612. In an example, the processor-executable instructions, when executed on a processor 616 of the device 608, are configured to perform a method, such as at least some of the exemplary method 500 of FIG. 5, for example. In an example, the processor-executable instructions, when executed on the processor 616 of the device 608, are configured to implement a system, such as at least some of system 400 of FIG. 4, for example.

2.4. Search Engine and Service

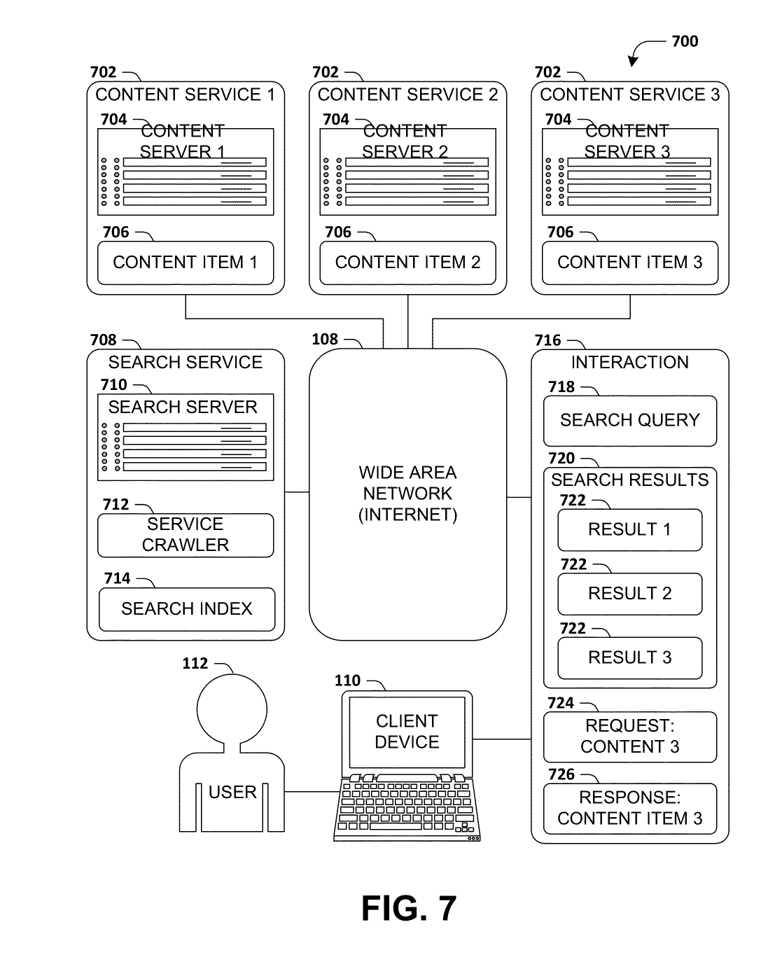

FIG. 7 is an interaction diagram of a scenario 700 a search engine and/or service that provides search results in response to a search query 718 on behalf of a user 112 and/or a client device 110. In this scenario 700, a set of content services 702 respectively comprise a content server 704 that provides access to a set of content items 706, such as text articles, pictures, video, audio, applications, data files, and/or output from devices such as cameras. A search service 708 is provided, comprising a search server 710 that interacts with the content services 702 over the wide area network 108, such as the Internet, to index the content items 706 provided thereby. For example, the search server 710 may utilize a service crawler 712 that iteratively explores the content services 702 and generates a search index 714 correlating the content items 706 of respective services 702 with various aspects, such as the name, logical address, object type, involved topics, and/or the producer and/or owner of the content item 706. The search service 708 may be deployed in a distributed manner across at least two search servers, which may be organized by role (e.g., a first search server maintaining the search index 714, and a second search server interacting with users and/or client devices) and/or geographically (e.g., various search servers may be provided to service client devices in different physical locations). Components may be duplicated within the search service 708; e.g., two or more search servers may be provided to facilitate the reliability, response time, and/or scalability of the search service 708.

As further illustrated in the scenario 700 of FIG. 7, the user 112 of the client device 110 may engage in an interaction 716 with the search service 708 and/or content services 702 in the following manner. The user 112 may submit the search query 718, such as a set of search terms, to the search service 708. The search server 710 may compare the search query 718 with the search index 714 to identify a search result set 720, comprising one or more search results 722 that respectively identify a content item 706 stored by a content service 702. The search service 708 may send the search result set 720 back to the client device 110 in fulfillment of the search query 718, and the client device 110 may present the search result set 720 to the user 112. The search results 722 of the search result set 720 may also be sorted and/or ranked by relevance to the search query 718, by chronology, and/or by content service 702. If the user 112 selects a search result 722, the client device 110 may submit a request 724 for the content item 706 associated with the selected search result 722 to the consent service 702 storing the content item 706. The content server 704 may provide the content item 706 in response to the request 724, and the client device 110 may then present the selected content item 706 to the user 112. The search service 708 may also utilize other techniques and/or components, such as an index storage component, a search component, a ranking component, a cache, a profile storage component, a logon component, a profile builder, and one or more application program interfaces (APIs). Many such search services 708 may be provided, and may variously utilize the techniques presented herein.

In techniques such as those presented herein, search services 708 may index content provided by the same search service 708 (e.g., a search service 708 for a locally stored file system, database, or content library); for content stored by other content services 702; and/or for content stored by one or more client devices 110 (e.g., a cloud indexing service that indicates the availability of data objects on a distributed set of client devices 110 of the user 112). Additionally, such search services 708 may index a variety of content, including messages generated by and/or sent to the user 112; text articles; fiction and/or nonfiction stories; facts about topics such as individuals, companies, places; pictures; audio and video recordings; applications; data objects such as files and databases; and/or products and/or services.

Search services 708 may receive and process many types of search queries 718 specified in a variety of modalities, including text, handwriting, speech, verbal cues or keywords, gestures, and/or body language. The search queries 718 may also be specified in a variety of organizational formats, such as a group of keywords, a Boolean logical structure or expression tree, or a natural-language speech. Additionally, the search service 708 may return search results 722 that correlate with content items 706 in various ways, such as a hyperlink to a uniform resource identifier (URI) of the content item 726; a description of the content item 706, such as a title, file type, generation date, synopsis, and/or preview version of the content item 706; and/or a copy of the full content item 706.

3. Usage of Terms

As used in this application, “component,” “module,” “system,” “interface,” and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller may be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “exemplary” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In an embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

1. A method of predicting a real-time economic indicator, comprising:
extracting a first piece of economic data from a first electronic message and a second piece of economic data from a second electronic message to obtain a set of extracted economic data;
determining a scale factor based upon historical economic data; and
determining a real-time economic indicator based upon the set of extracted economic data and the scale factor.

2. The method of claim 1, the first electronic message comprising at least one of:
an email, an instant message, or a social network message.

3. The method of claim 1, comprising:
receiving economic user feedback for the real-time economic indicator; and
adjusting the real-time economic indicator based upon the economic user feedback to obtain an adjusted real-time economic indicator.

4. The method of claim 3, the economic user feedback comprising at least one of a suggested economic data source, a suggested weighting factor for the suggested economic data source, or a physical sales receipt.

5. The method of claim 1, the first piece of economic data comprising a first sales receipt within a first email, and the second piece of economic data comprising a second sales receipt within a second email.

6. The method of claim 1, comprising:
providing a real-time feed of the real-time economic indicator to a client according to a license agreement.

7. The method of claim 1, comprising:
aggregating the set of extracted economic data according to a category, the category comprising at least one of a product, a product class, a seller, a seller class, a purchaser detail, a date/time of sale, a location, or a combination thereof.

8. The method of claim 1, the historical economic data comprising at least one of stock data, past product sales data, or gross domestic sales data.

9. The method of claim 1, comprising:
updating the real-time economic indicator in real-time based upon a third piece of economic data that is extracted from a third electronic message.

10. A system for predicting a real time economic indicator, comprising:
an economic data extraction component configured to:
extract a first piece of economic data from a first electronic message to obtain a first piece of extracted economic data;
a categorizing component configured to:
aggregate the first piece of extracted economic data into a first category;
a scaling component configured to:
determine a scale factor based on historical data; and
an indicator component configured to:
determine a real-time economic indicator for the first category based upon the scale factor and the first piece of extracted economic data.

11. The system of claim 10, the first piece of extracted economic data comprising a sales receipt for a purchase.

12. The system of claim 10, comprising:
a streaming component configured to:
create a real-time feed based upon the real-time economic indicator.

13. The system of claim 12, the streaming component configured to:
update the real-time economic indicator of the real-time feed based upon an evaluation of a second piece of economic data within a second electronic message.

14. The system of claim 10, the indicator component configured to:
receive economic user feedback for the real-time economic indicator; and
adjust the real-time economic indicator based upon the economic user feedback to obtain an adjusted real-time economic indicator.

15. The system of claim 10, the first category comprising at least one of a product, a product class, a seller, a seller class, a purchaser detail, a date/time of sale, or a location.

16. The system of claim 10, the real-time economic indicator comprising at least one of a leading indicator or a coincident indicator.

17. A non-transitory computer readable medium comprising computer executable instructions that when executed by a processor perform a method for predicting a real-time economic indicator, comprising:
extracting a first piece of economic data from a first electronic message and a second piece of economic data from a second electronic message to obtain a set of extracted economic data, at least one of the first electronic message or the second electronic message comprising an email, an instant message, or a social network message;
aggregating the set of extracted economic data into a first category;
determining a scale factor based upon historical economic data for the first category; and
determining a real-time economic indicator for the first category based upon the set of extracted economic data and the scale factor.

18. The method of claim 17, comprising:
receiving economic user feedback for the real-time economic indicator; and
adjusting the real-time economic indicator based upon the economic user feedback to obtain an adjusted real-time economic indicator.

19. The method of claim 17, the first piece of economic data comprising a first sales receipt within a first email, and the second piece of economic data comprising a second sales receipt within a second email.

20. The method of claim 17, comprising:
updating the real-time economic indicator in real-time based upon a third piece of economic data that is extracted from a third electronic message.
